(19) United States
(12) Patent Application Publication
(10) Pub. No.: US 2008/0169668 A1
(43) Pub. Date: Jul. 17, 2008

(54) VEHICLE TRUNK INTERNAL STORAGE COMPARTMENT STRUCTURE

(75) Inventor: Tomohiro MURAMATSU, Nagoya-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 11/970,696

(22) Filed: Jan. 8, 2008

(30) Foreign Application Priority Data
Jan. 15, 2007 (JP) 2007-006015

(51) Int. Cl. B60R 7/04; B60R 7/00

(52) U.S. Cl. 296/37.14; 224/539

(57) ABSTRACT

A vehicle trunk internal storage compartment structure including a floor portion formed with a storage recess open toward the vehicle top; a lid body covering the storage recess opening; and a link member connecting the lid body with the storage recess inside. First and second end portions of the link member are connected to the lid body and the storage recess inside, respectively, so as to be relatively rotatably and relatively moveable with respect thereto. A first end portion guide member is provided to the lid body enabling guiding of the first end portion of the link member in a direction orthogonal to the link member relative rotation axis with respect to the lid body. When stowing the vehicle seat, a coupling mechanism couples the lid body to the movement of the vehicle seat and opens the lid body by the seat stowing operation alone.

### CROSS-REFERENCE TO RELATED APPLICATION

This application claims priority under 35 U.S.C 119 from Japanese Patent Application No. 2007-6015, the disclosure of which is incorporated by reference herein.

### BACKGROUND OF THE INVENTION

1. Field of the Invention

The present invention relates to a vehicle trunk internal storage compartment structure in which a storage recess can be opened or closed off by covering with a lid body.

2. Description of the Related Art

In vehicles to which seat stowing compartments have been formed, usually the lid body of the seat stowing compartment must be taken off when stowing the seat. As an example of a structure in which it is not necessary to remove the lid body, there is, for example, a structure in which, when a vehicle seat has been moved between a seat use position and a stowing position, the lid body opens or closes the seat stowing compartment according to this movement (see, for example, Japanese Patent Application Laid-Open (JP-A) No. 2005-96534). In such a structure, a bracket or the like for opening or closing the lid body, is mounted to a vehicle seat and a lid body is connected to the vehicle rear direction side edge portion of the opening of the seat stowing compartment by a hinge.

In such a structure as above, however, when it is desired to store objects, other than the seat, in the storage recess from the vehicle rear direction side, the lid body gets in the way of this action, and with regard to this point there is room for improving the ease of use.

### SUMMARY OF THE INVENTION

In consideration of the above circumstances, the present invention provides a vehicle trunk internal storage compartment structure that may improve the usability during storing.

A vehicle trunk internal storage compartment structure according to a first aspect of the present invention includes: a floor portion that is formed with a storage recess that opens toward the vehicle up direction side in a vehicle trunk; a lid body, that covers the opening of the storage recess so that the storage recess is able to be opened and to be closed off, a link member, a first end portion of the link member being relatively rotatably connected to the lid body side and a second end portion of the link member being relatively rotatably connected at the floor portion side at the inside of the storage recess; a first end portion guide member, provided at the lid body side and capable of guiding the first end portion of the link member in a direction that is orthogonal to the axial line of relative rotation of the link member with respect to the lid body side.

According to the vehicle trunk internal storage compartment structure of the above aspect, the link member has a first end portion that is relatively rotatably connected to the lid body side and has a second end portion of the link member that is relatively rotatably connected at the floor portion side at the inside of the storage recess, and a first end portion guide member, provided at the lid body side, is capable of guiding the first end portion of the link member in a direction that is orthogonal to the axial line of relative rotation of the link member with respect to the lid body side. Therefore, the lid body may be moved in directions to open and close off the opening of the storage recess, may be moved in the vehicle up-down direction, and may also be moved in rotational directions about the axial line. This means that an occupant may displace the lid body appropriately according to the use being made of the storage recess, so as to facilitate the use thereof.

In the vehicle trunk internal storage compartment structure of the first aspect of the present invention, the axial line of relative rotation of the link member with respect to the lid body side may be set substantially parallel to a direction within the plane direction of the top surface of the lid body when the lid body is in a state of closing off the opening.

According to the vehicle trunk internal storage compartment structure of the above described configuration, the axial line of relative rotation of the link member with respect to the lid body side is set substantially parallel to a direction within the plane direction of the top surface of the lid body when the lid body is in a state of closing off the opening, and therefore, when the lid body is rotated about the axial line the top and bottom faces of the lid body may be swapped over.

Namely, according to the vehicle trunk internal storage compartment structure of the configuration described above, there is the superior effect that the top and bottom faces of the lid body may be swapped over with an easy manipulation thereof.

In the vehicle trunk internal storage compartment structure of the first aspect of the invention, the axial line of relative rotation of the link member with respect to the floor portion side may be set substantially parallel to a direction within the plane direction of the top surface of the lid body when the lid body is in a state of closing off the opening.

According to the vehicle trunk internal storage compartment structure of the above described configuration, since the axial line of relative rotation of the link member with respect to the floor portion side is set substantially parallel to a direction within the plane direction of the top surface of the lid body when the lid body is in a state of closing off the opening, the relative dispositional relationship between the lid body and the first end portion of the link member may be efficiently changed by rotational movement of the link member about the axial line.

Namely, according to the vehicle trunk internal storage compartment structure in the configuration described above, there is the superior effect that the relative dispositional relationship between the lid body and the first end portion of the link member may be efficiently changed.

In the vehicle trunk internal storage compartment structure of the first aspect of the invention, a second end portion guide member may be provided within the storage recess at the floor portion side, the second end portion guide member being capable of guiding the second end portion of the link member in a direction that is orthogonal to the axial line of relative rotation of the link member with respect to the floor portion side.

According to the vehicle trunk internal storage compartment structure of the configuration described above, the second end portion guide member provided within the storage recess at the floor portion side is capable of guiding the second end portion of the link member in a direction that is orthogonal to the axial line of relative rotation of the link member with respect to the floor portion side, and therefore the lid body is capable of a wider range of movements.

Namely, according to the vehicle trunk internal storage compartment structure of the configuration described above, the superior effect is displayed in that a wider range of movements are made possible for the lid body, and the degrees of freedom for placing the lid body may be increased.

In the vehicle trunk internal storage compartment structure of the first aspect of the present invention, the storage recess may be provide at the seat rear direction side of the vehicle seat, and the vehicle trunk internal storage compartment structure may further include: a stowing mechanism that moves the vehicle seat from the seat use position and stows the vehicle seat in the storage recess; and a coupling mechanism, coupling the lid body to movement of the vehicle seat in the state in which the vehicle seat is being moved by the stowing mechanism in the direction of stowing in the storage recess, and moving the lid body out of the way from a position in which it is covering the opening of the storage recess.

According to the vehicle trunk internal storage compartment structure of the configuration described above, the lid body is coupled to movement of the vehicle seat in the state in which the vehicle seat is being moved by the stowing mechanism in the direction of stowing in the storage recess, and moves the lid body out of the way from a position in which it is covering the opening of the storage recess. Therefore, when the vehicle seat is being stowed, the lid body is opened and the vehicle seat is stowed even without a having to carry out a separate operation to open the lid body.

Namely, according to the vehicle trunk internal storage compartment structure of the configuration described above, the superior effect is displayed in that when the vehicle seat is being stowed, the lid body is opened and the vehicle seat is stowed even without carrying out a separate operation to open the lid body.

In the vehicle trunk internal storage compartment structure of the first aspect of the present invention, the coupling mechanism, in the state in which the vehicle seat is being moved by the stowing mechanism in the direction of stowing in the storage recess, may press the lid body positioned covering the opening of the storage recess in a direction that is toward the opposite side to the seat use position side and may move the lid body.

According to the vehicle trunk internal storage compartment structure of the configuration described above, the coupling mechanism, in the state in which the vehicle seat is being moved by the stowing mechanism in the direction of stowing in the storage recess, presses the lid body positioned covering the opening of the storage recess in a direction that is toward the opposite side to the seat use position side and moves the lid body. Therefore, while being of a comparatively simple configuration, no separate operation to open the lid body is required when stowing the vehicle seat.

Namely, according to the vehicle trunk internal storage compartment structure of the configuration described above, the superior effect is displayed in that, by a comparatively simple configuration, the lid body may be moved out of the way when stowing the vehicle seat without carrying out a separate operation to open the lid body.

In the storage compartment structure configured as above, an edge portion of the opening to the storage recess, at the opposite side of the storage recess from the seat use portion side, may be configured so as to be angled, on progression in the vehicle up direction, toward the opposite side from the seat use portion side.

According to the vehicle trunk internal storage compartment structure of the configuration described above, since the edge portion of the opening to the storage recess, at the opposite side of the storage recess from the seat use portion side, is angled, on progression in the vehicle up direction, toward the opposite side from the seat use portion side, when stowing the vehicle seat if the lid body is pushed in the direction that is toward the opposite side to the seat use position side, the lid body may be guided by the angled edge portion and may readily move in the direction toward the opposite side to the seat use position side, from the position of covering the opening of the storage recess.

Namely, according to the vehicle trunk internal storage compartment structure of the configuration described above, the superior effect is displayed in that movement of the lid body when stowing the vehicle seat may be further facilitated.

As has been explained above, the vehicle trunk internal storage compartment structure according to the present invention displays the superior effect in that the ease of use when stowing may be increased.

### BRIEF DESCRIPTION OF THE DRAWINGS

FIG. 1 is a perspective view showing a rear portion of a vehicle trunk to which a vehicle trunk internal storage compartment structure according to an exemplary embodiment of the present invention has been applied.

FIG. 2 is a schematic side view cross-section taken on cross-section 2-2 of FIG. 1.

FIG. 3 is an exploded perspective view showing a deck board, link members, and support rails in an exemplary embodiment of the present invention.

FIG. 4 is a schematic side view cross-section showing movement of a vehicle seat in the direction of storage into a storage recess.

FIG. 5 is a schematic side view cross-section showing a state in which a vehicle seat that has been stored in a storage recess.

FIG. 6 is a schematic side view cross-section showing a state in which a deck board has been moved in the vehicle front direction from the state of FIG. 5.

FIG. 7 is a schematic side view cross-section showing an example of using a deck board in a flipped over state.

FIG. 8 is a schematic side view cross-section showing an example of use by standing a deck board up at the front side in a storage recess.

### DETAILED DESCRIPTION OF THE INVENTION

### Configuration of an Exemplary Embodiment

Explanation will now be given of an exemplary embodiment of a vehicle trunk internal storage compartment structure in an exemplary embodiment of the present invention, with reference to the drawings. It should be noted that in the drawings the arrow UP shows the vehicle up direction and the arrow FR shows the vehicle front direction.

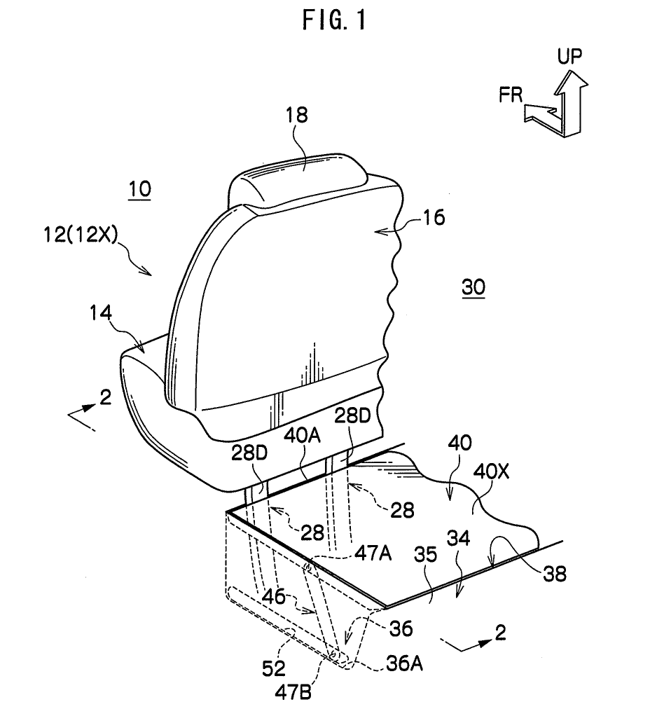

As shown in FIG. 1, a vehicle seat 12 that is disposed in a vehicle cabin 10 is configured to include: a seat cushion 14, supporting the buttocks and thighs of an occupant; a seat back 16, supported at a rear edge portion of the seat cushion 14 so as to be able to tilt, and supporting the back of an occupant; and a head rest 18, provided at a top edge portion of the seat back 16 so as to be adjustable in the up-down direction, and supporting the head of an occupant. It should be noted that the vehicle seat 12 in the present exemplary embodiment is a third seat (third row seat) that is stowable to the rear direction thereof.

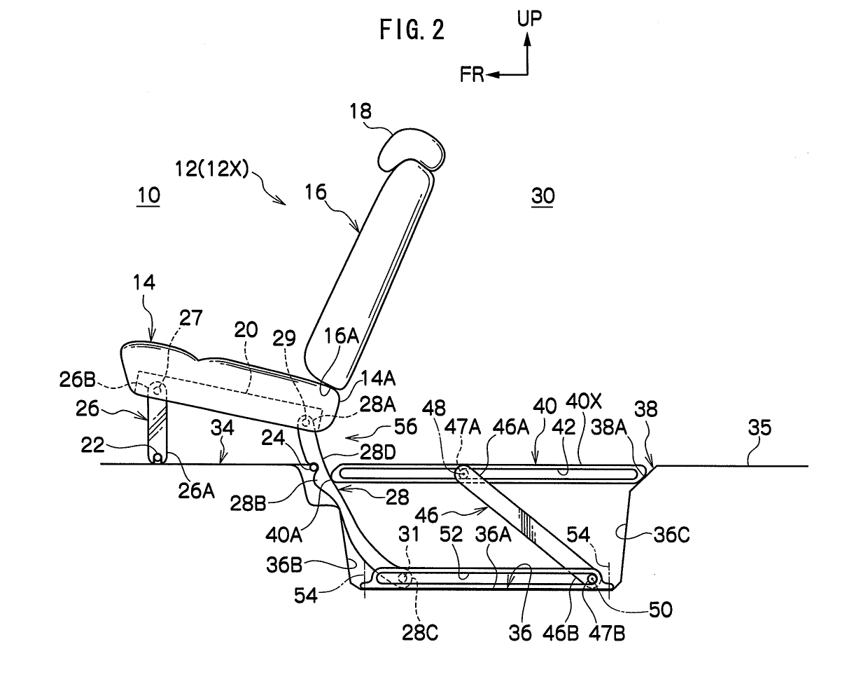

As shown in FIG. 2, there is a seat cushion frame 20 provided within the seat cushion 14. Seat cushion springs (omitted in the figures) span across the seat cushion frame 20, and there is a seat cushion pad (omitted in the figures) disposed above these seat cushion springs, and the surface of the seat cushion pad is furthermore covered with a covering material (omitted in the figures).

There are plural front lock-on portions 22 mounted, along the vehicle width direction below a front portion of the seat cushion 14, to a floor portion 34 that serves as a vehicle floor portion. Front leg lower portions 26A of front legs 26, which are attached to a front portion side of the seat cushion 14, are locked to these front lock-on portions 22. Plural of the front legs 26 are provided along the vehicle width direction, corresponding to the front lock-on portions 22, and the front leg lower portions 26A are mountable to, and demountable from, the front lock-on portions 22 of the floor portion 34, and also the front leg upper portions 26B are attached to the seat cushion 14 (seat cushion frame 20) so as to be able to rotate about a shaft 27 that is in the vehicle width direction.

There are plural rear lock-on portions 24 mounted to the floor portion 34 along the vehicle width direction below a rear portion of the seat cushion 14. Length direction intermediate portions 28B of rear legs 28, serving as long stowing mechanisms, which are attached to a rear portion side of the seat cushion 14, are locked to these rear lock-on portions 24. Plural of the rear legs 28 are provided along the vehicle width direction, corresponding to the rear lock-on portions 24, and the length direction intermediate portions 28B are mountable to, and demountable from, the floor portion 34 side of the rear lock-on portions 24, and also rear leg upper portions 28A, which are the ends at one side of the length direction intermediate portions 28B, are attached to the seat cushion 14 (seat cushion frame 20) so as to be able to rotate about a shaft 29 that is in the vehicle width direction. Furthermore, rear leg lower portions 28C, which are the ends at the other side of the rear legs 28, are attached at a bottom wall 36A of a storage recess 36 so as to be able to rotate about a shaft 31 that is in the vehicle width direction.

To the vehicle rear direction side (seat rear side) of the vehicle seat 12 in a seat use position 12X is a vehicle trunk 30, as shown in FIG. 2, and the storage recess 36 is formed at the floor portion 34 of the vehicle cabin 10, the storage recess 36 being formed as a substantially rectangular recess that is open to the vehicle up direction side. The storage recess 36 forms a storage compartment (storage space) and is configured with the bottom wall 36A forming the base thereof, a front wall 36B curving around up in substantially the vehicle up direction from the front edge of the bottom wall 36A, a rear wall 36C curving around up in substantially the vehicle up direction from the rear edge of the bottom wall 36A, and side walls (omitted in the figures) that curve around in substantially the vehicle up direction from the two ends in the vehicle width direction of the bottom wall 36A. It should be noted that, in the present exemplary embodiment, the vehicle rear direction side of the storage recess 36 in the floor portion 34 is a plate-shaped rear side plate 35.

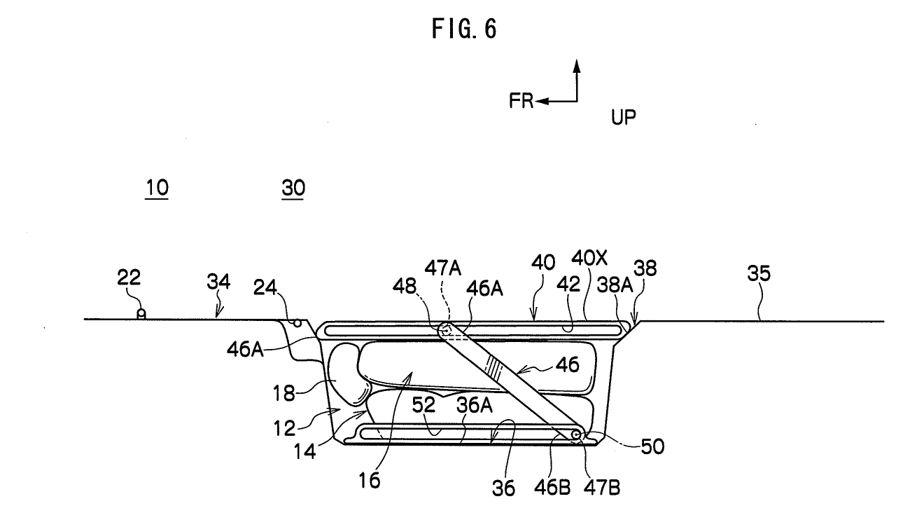

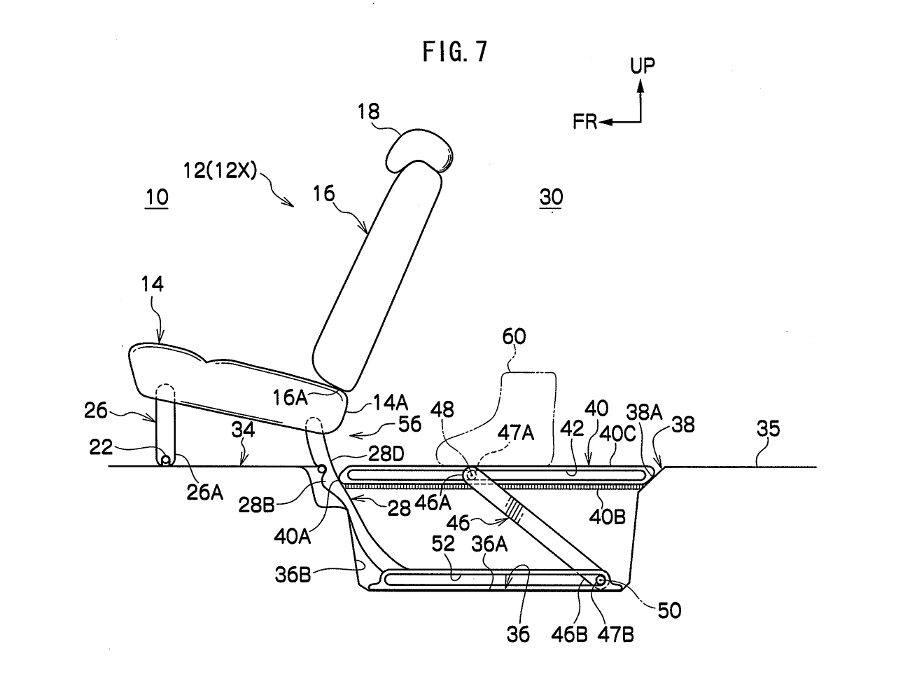

The rear legs 28 that are attached to the rear portion side of the seat cushion 14 also function as a seat storage link, and serve as a stowing mechanism for stowing (storing) the vehicle seat 12 in the storage recess 36 that is provided to the seat rear side thereof, by moving the vehicle seat 12 from the seat use position 12X (the position shown in FIG. 2), so as to store the vehicle seat 12 in a folded-up state within the storage recess 36, as shown in FIG. 6. That is to say, the seat storage space is formed by the storage recess 36. It should be noted that, in the state in which the vehicle seat 12 is stowed within the storage recess 36, the vehicle trunk 30 becomes an expanded vehicle trunk including the space where the vehicle seat 12 was disposed before it was stowed. An opening 38 to the storage recess 36 is covered with a movable deck board 40 (luggage board), serving as a substantially rectangular flat plate shaped lid body, and thereby the storage recess 36 is able to be opened or closed-off. The deck board 40 has a carpeted face 40B on one face side thereof (see FIG. 7), and a resin face 40C on the other face side thereof (see FIG. 7). As shown in FIG. 2, at a portion corresponding to the boundary of the rear wall 36C and a rear side plate 35, that is to say at a rear edge portion 38A that is on the opposite side (the vehicle rear direction side) of the opening 38 of the storage recess 36 to the side of the seat use position 12X, there is configured a guiding angled face (guide forming face) that is angled, on progression in the vehicle up direction, toward the opposite side (the vehicle rear direction side) to the side of the seat use position 12X, the rear edge portion 38A being used for guiding (for assisting the rearward movement) when the deck board 40 is moved.

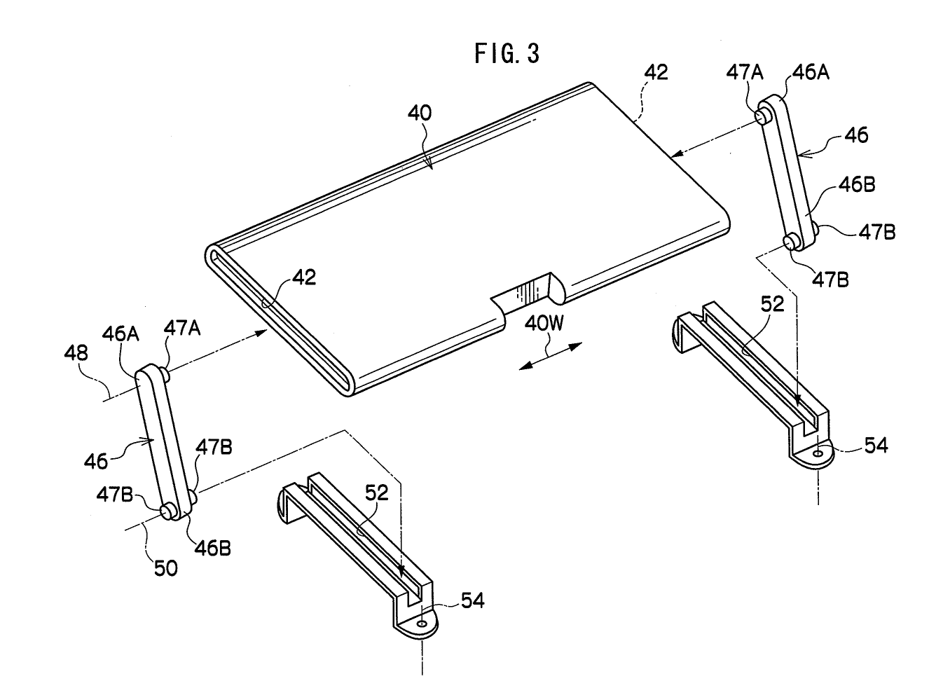

There are rails 42, serving as first end portion guide members, formed to the deck board 40 at both side portions in the board width direction (the direction of arrow 40W, this being the same direction as the vehicle width direction when mounted), as shown in FIG. 3. The rails 42 extend along the board side face length direction, that is to say extend in a straight line orthogonal to the board width direction. There are first protrusions 47A provided to end portions 46A of link members 46, and the first protrusions 47A are connected to the rails 42 provided in this manner to the sides of the deck board 40, so as to be able to relatively rotate. The link members 46 are formed in the shape of arms, and the first protrusions 47A that are formed at the end portions 46A at one end of the link members 46 protrude out in a direction that is at right angles to the length direction of the link members 46 and is also the direction in which the pair of first protrusions 47A of the link members 46 approach each other. The first protrusions 47A are disposed intruding into the rails 42 and engage therewith so that they are able to slide and relatively rotate thereto. Namely, the first protrusions 47A are slidable along the length direction of the rails 42, and also are relatively rotatable with respect to the deck board 40 about an axial line 48 that is the protruding direction of the first protrusions 47A.

As shown in FIG. 2, the angle formed by the link members 46 to the deck board 40 is variable, by relative rotation with respect to the sides of the deck board 40 about the axial line 48 of the link members 46. The relative rotation axial line 48 of the link members 46 with respect to the sides of the deck board 40 is set, in the present exemplary embodiment along the vehicle width direction, such that, it is substantially parallel to a direction along the plane direction of the top face 40X of the deck board 40 in the state in which the deck board 40 has closed off the opening 38 (substantially the same direction as along the plane direction of the general face of the floor 34 (the upper face of the rear side plate 35 or the like, for example)). The rails 42, in which the first protrusions 47A are disposed, are able to guide the end portions 46A (to guide the first protrusions 47A) at one end of the link members 46 in a direction that is orthogonal to the relative rotation axial line 48 of the link members 46 relative to the sides of the deck board 40.

There are second protrusions 47B (see FIG. 3) provided to end portions 46B at the other end in the length direction of the link members 46, at the floor portion 34 side. The second protrusions 47B are relatively rotatably connected to support rails 52, serving as second guide members, at the inside of the storage recess 36. As shown in FIG. 3, the second protrusions 47B protrude out in a direction that is orthogonal to the length direction of the link members 46, and the second protrusions 47B also protrude out from the pair of link members 46 in the direction in which they approach each other, as well as in the direction away from each other. As shown in FIG. 1, the second protrusions 47B are disposed in the support rails 52, the support rails 52, extending in the vehicle front-rear direction within the storage recess 36 on both sides in the vehicle width direction, are fixed by fasteners 54 (see FIG. 2), such as bolts or the like, at the body side of the bottom wall 36A of the storage recess 36. As shown in FIG. 3, the second protrusions 47B are disposed intruding into the support rails 52, and engage therewith so as to be slidable and able to relatively rotate thereto. Namely, the second protrusions 47B are slidable along the length direction of the support rails 52 (the same direction as the vehicle front-rear direction), and are also relatively rotatable with respect to the support rails 52 about an axial line 50 that is along the protrusion direction of the second protrusions 47B themselves.

As shown in FIG. 2, the angle formed by the link members 46 to the support rails 52 is variable, by relative rotation with respect to the support rails 52 about the axial line 50 of the link members 46. The relative rotation axial line 50 of the link members 46, with respect to the support rails 52 on the floor portion 34 side, in the same manner as the relative rotation axial line 48 of the link members 46 with respect to the deck board 40 side, is set substantially parallel to a direction along the plane direction of the top face 40X of the deck board 40 (substantially the same direction as along the plane direction of the general face of the floor 34 (the upper face of the rear side plate 35 or the like, for example)) when in the state in which the deck board 40 has closed off the opening 38, in the present exemplary embodiment, substantially parallel to the axial line 48. That is to say the relative rotation axial line 50 is set along the vehicle width direction. The support rails 52, provided at the floor portion 34 side within the storage recess 36, guide the end portions 46B (guide the second protrusions 47B) at the other end of the link members 46, in a direction that is orthogonal to the relative rotation axial line 50 (see FIG. 3) of the link members 46 relative to the support rails 52 on the floor portion 34 side (in the present exemplary embodiment, a direction that is substantially the vehicle front-rear direction). The link members 46 are thereby able to support the deck board 40.

As shown in FIG. 1 and FIG. 2, in the state in which the vehicle seat 12 is in the seat use position 12X and the deck board 40 is positioned covering the opening 38 of the storage recess 36, rear face portions 28D of the rear legs 28, portions facing toward the vehicle rear direction, contact with front portions 40A of the deck board 40, portions facing toward the vehicle front direction.

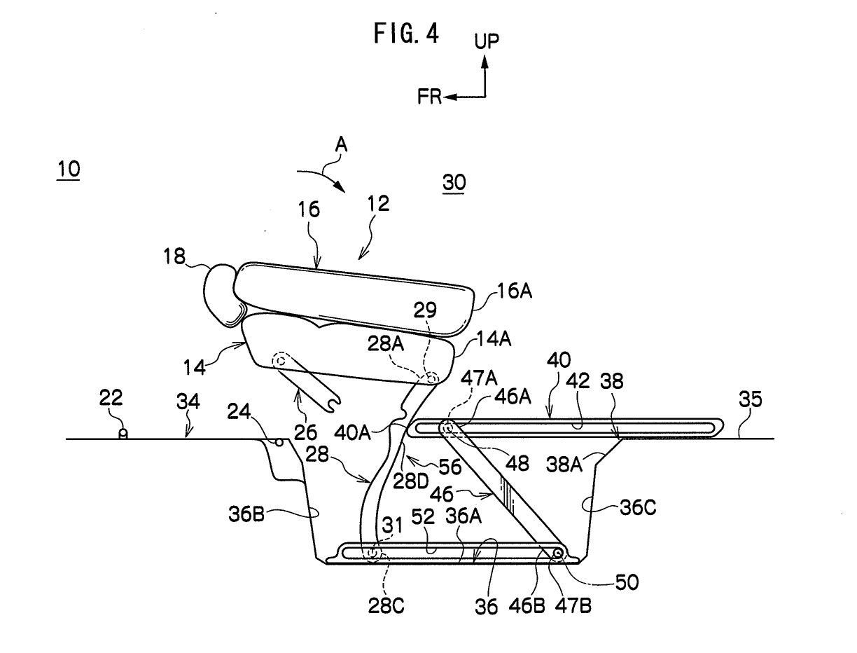

Furthermore, in the present exemplary embodiment, the rear legs 28 and portions of the vehicle seat 12 (the lower edge 16A of the seat back 16 and the rear edge 14A of the seat cushion 14), as shown in FIG. 4, configure a coupling mechanism 56. This coupling mechanism 56, when the vehicle seat 12 is moving using the rear legs 28 in the direction to store within the storage recess 36 (the direction of arrow A), couples the deck board 40 to the movement of the vehicle seat 12 and moves the deck board 40 in a direction out of the way from a position in which it is covering the opening 38 of the storage recess 36. More specifically, at least one of the rear face portions 28D of the rear legs 28 and/or portions of the vehicle seat 12 (the lower edge 16A of the seat back 16 and the rear edge 14A of the seat cushion 14) press the front portions 40A of the deck board 40 in the direction that is to the opposite side to the seat use position 12X side (see FIG. 2) and move the deck board 40 out of the way. In other words, the movement of the rear legs 28 and the vehicle seat 12 is the source of kinetic force moving the moveable deck board 40 toward the vehicle rear direction side.

### Operation and Effects of the Exemplary Embodiment

Explanation will now be given of the operation and effects of the exemplary embodiment described above.

As shown in FIG. 2, when the vehicle seat 12 is in the seat use position 12X (before stowing the seat), the storage recess 36 may be used as storage space below the deck board 40, and various items to be stored may be stored therein. Since the deck board 40 is able to open or close off the opening 38 of the storage recess 36, when items to be stored are being stored an occupant moves the deck board 40 from the position covering the opening 38.

In the link members 46 that are connected to the deck board 40, the first protrusions 47A provided to the end portions 46A at one end of the link members 46 are connected to the deck board 40 side so as to be relatively rotatable, and the second protrusions 47B provided to the end portions 46B at the other end of the link members 46 are connected relatively rotatable to the support rails 52 provided inside the storage recess 36. The rails 42, configured as grooves provided in the sides of the deck board 40, are able to guide the end portions 46A at one end of the link members 46 in a direction that is orthogonal with respect to the relative rotation axial line 48 of the link members 46 with respect to the deck board 40 side (see FIG. 3), and even without the deck board 40 being removed the deck board 40 may be moved in the direction of opening and closing the opening 38 of the storage recess 36, may be moved in the vehicle up-down direction and may be moved in the rotational direction about the axial line 48 (there are many variations available for the movement of the deck board). Furthermore, since the support rails 52, which are provided at the floor portion 34 side within the storage recess 36, guide the end portions 46B at the other end of the link members 46 in a direction that is orthogonal to the relative rotation axial line 50 of the link members 46 with respect to the floor portion 34 side (see FIG. 3) (the vehicle front-rear direction in the present exemplary embodiment), the deck board 40 is capable of moving in an extended range. It should be noted that, by the above, removal of the deck board 40 becomes unnecessary, and therefore there is also no problem of where to put a removed deck board.

The relative rotation axial line 48 of the link members 46 with respect to the deck board 40 side is set to be substantially parallel to a direction along the plane direction of the top face 40X in the state in which the deck board 40 closes off the opening 38, thereby when the deck board 40 is rotated about the axial line 48, the top and bottom faces of the deck board 40 may be swapped over. Furthermore, the relative rotation axial line 50 of the link members 46 with respect to the support rails 52 on the floor portion 34 side is set to be substantially parallel to a direction along the plane direction of the top face 40X in the state in which the deck board 40 closes off the opening 38, thereby when the link members 46 is rotated about the axial line 50, the relative positional relationship of the deck board 40 and the end portions 46A at one end of the link members 46 may be efficiently changed.

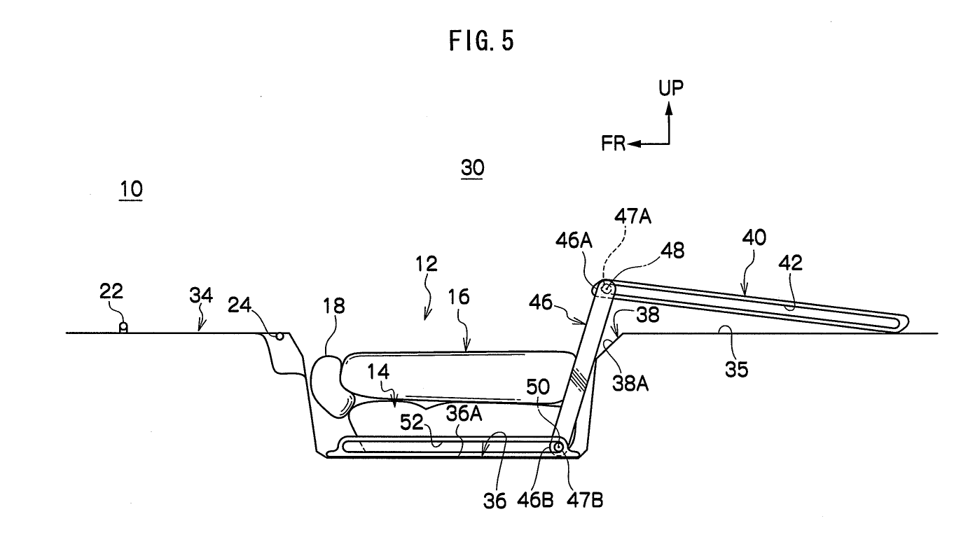

As shown in FIG. 4, in the state in which the vehicle seat 12 is moved in the direction of stowing in the storage recess 36 by the rear legs 28 (the direction of arrow A), as the coupling mechanism 56 couples the movement of the vehicle seat 12 to the deck board 40, since the deck board 40 which is in the position of covering the opening 38 of the storage recess 36 is pressed in the direction (the vehicle rear direction side) that is to the opposite side to that of the seat use position 12X side (see FIG. 2) and the deck board 40 is moved together with the link members 46, when stowing the vehicle seat 12 simply by carrying out the seat stowing operation alone, the deck board 40 is (automatically) opened (the opening 38 of the storage recess 36 is placed in the open state) and the vehicle seat 12 is stowed, as shown in FIG. 5, even without separately carrying out the deck board 40 opening operation.

In particular, in the present exemplary embodiment, the rear edge portion 38A, which is on the opening 38 of the storage recess 36 at the opposite side to the side of the seat use position 12X (see FIG. 2), is angled, on progression in the vehicle up direction, toward the direction (vehicle rear direction side) that is the opposite side to the seat use position 12X side (see FIG. 2), therefore when the deck board 40 is pressed toward the direction that is the opposite side to the seat use position 12X when stowing the vehicle seat 12, the deck board 40 is guided by the angled rear edge portion 38A and readily moves, from the position of covering the opening 38 of the storage recess 36, in the direction that is toward the opposite side to the seat use position 12X side.

In this manner, when stowing the vehicle seat 12, the deck board 40 may be readily moved and the vehicle seat 12 may be stowed even without carrying out a separate opening operation of the deck board 40. It should be noted that after stowing the vehicle seat 12 within the storage recess 36, an occupant manually pushes and moves the deck board 40 that has been disposed above the rear side plate 35 in the vehicle up direction, as shown in FIG. 5, toward the vehicle front direction, and the deck board 40 is then disposed in the original position, the position covering the opening 38 of the storage recess 36, as shown in FIG. 6.

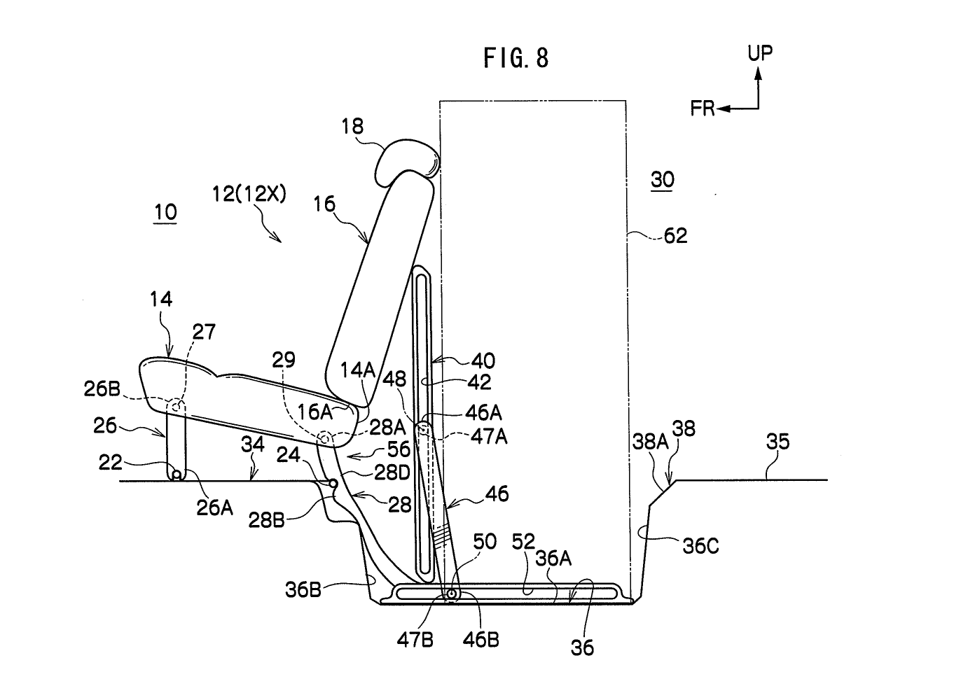

An occupant may also displace the deck board 40 appropriately according to the use being made of the storage recess 36 so as to facilitate the use thereof, and a disposition may be chosen that facilitates and matches the way the storage recess 36 is being used. Such other uses include, for example, reversing (flipping over) the deck board 40 by rotational movement about the axial line 48, as shown in FIG. 7, so that the resin face 40C is facing toward the vehicle up direction side, and a dirty object 60 may be placed on the resin face 40C rather than on the carpeted face 40B. Furthermore, as shown in FIG. 8, when loading a large load 62, for example, the deck board 40 and the link members 46 may be tilted toward the side of the front wall 36B of the storage recess 36 (or toward the rear wall 36C side) and by disposing the deck board 40 in an upright state (such as by latching the deck board 40 to the seat back 16), the load 62 may be placed within the storage recess 36. In such a case, it is not necessary to remove the deck board 40, but it is, however, also possible to fully utilize the space below the floor and to secure the load (storage) space required for loading the tall load 62.

According to the vehicle trunk internal storage compartment structure of the present exemplary embodiment, as has been explained above, a wide range of movements are made possible for the deck board 40, and the degrees of freedom for placing the deck board 40 may be increased, and in other words, multiple ways of using the deck board 40 may be made, and as a result, the ease of use of when carrying out storing may be increased.

### Supplementary Explanation with Examples

It should be noted that whereas in the above exemplary embodiment the vehicle seat 12 is moved from the seat use position 12X and stowed in the storage recess 36 by the rear legs 28 serving as a stowing mechanism, however, stowing mechanisms such as those disclosed, for example, in JP-A No. 2005-186678 may be used as a stowing mechanism, and other stowing mechanisms such as link mechanisms that may be fitted to, and removed from, the floor side, provided as separate items from seat legs and that move a vehicle seat from the seat use position and stow the vehicle seat within a storage recess may be used.

Furthermore, whereas in the above exemplary embodiment there are support rails 52 provided within the storage recess 36, the end portions 46B at the other end of the link members 46 may, for example, be connected at a vehicle rear direction portion of the bottom wall 36A in the storage recess 36 so as to be able to relatively rotate about an axis along the vehicle width direction, without providing the support rails 52.

Also, in the above exemplary embodiment, in the state in which the vehicle seat 12 is being moved by the rear legs 28 in the direction of stowing within the storage recess 36, the coupling mechanism 56 presses and moves the deck board 40, which is placed in the position covering the opening 38 of the storage recess 36, in the direction that is toward the opposite side to the seat use position 12X side. However, other coupling mechanisms may be used such as, for example, a coupling mechanism that has, for example, a position detector that detects the position of the vehicle seat and has a displacing mechanism that displaces a lid body based on an output signal from the position detector, and the coupling mechanism may electrically couple movement of the vehicle seat in the state of being stowed in a storage recess 36 to the lid body, and move the lid body in a direction that is out of the way from the position covering the opening of a storage recess.

In addition, in the above exemplary embodiment, there are rails 42 formed as first guide members to the deck board 40, serving as a lid body, however, a configuration may be adopted in which separate first end portion guide members are fixed to the lid body. Also, whereas in the above exemplary embodiment support rails 52 are separate members fixed as second end portion guide members at the floor portion 34, serving as a floor portion, the second end portion guide members may be configured integrally to the floor portion.

Still further, whereas in the above exemplary embodiment, the rear side plate 35 is provided at the vehicle rear direction side of the storage recess 36, a structure in which a rear bumper is disposed in the vicinity of the vehicle rear direction side of a storage recess is suitable, and in such a case, a lid body may be caused to slide over the top of the rear bumper (in the state in which the luggage door is open).

It should be noted that in the above exemplary embodiment there is a pair of, i.e. two, link members 46 provided for each deck board 40, however the number of link members provided for lid member is not necessarily two. In the above exemplary embodiment the relative rotation axial line 48 of the link members 46 with respect to the deck board 40 side, and the relative rotation axial line 50 of the link members 46 with respect to the support rails 52 on the floor portion 34 side, are set so as to be substantially parallel to the plane direction of the top face 40X of the deck board 40, in the state in which the deck board 40 closes off the opening 38. However, while this configuration is preferable, the relative rotation axial line of the link members with respect to the lid body side, and the relative rotation axial line of the link members with respect to the floor portion side, may be set in a direction that is not parallel to directions in the plane direction of the top face of the lid body when the lid body closes off the opening, and instead is a direction that intersects therewith.

What is claimed is:

1. A vehicle trunk internal storage compartment structure comprising:
a floor portion that is formed with a storage recess that opens toward the vehicle up direction side in a vehicle trunk;
a lid body, that covers the opening of the storage recess so that the storage recess is able to be opened and to be closed off,
a link member, a first end portion of the link member being relatively rotatably connected to the lid body side and a second end portion of the link member being relatively rotatably connected at the floor portion side at the inside of the storage recess;
a first end portion guide member, provided at the lid body side and capable of guiding the first end portion of the link member in a direction that is orthogonal to the axial line of relative rotation of the link member with respect to the lid body side.

2. The vehicle trunk internal storage compartment structure according to claim 1, wherein the axial line of relative rotation of the link member with respect to the lid body side is set substantially parallel to a direction within the plane direction of the top surface of the lid body when the lid body is in a state of closing off the opening.

3. The vehicle trunk internal storage compartment structure according to claim 1, wherein the axial line of relative rotation of the link member with respect to the floor portion side is set substantially parallel to a direction within the plane direction of the top surface of the lid body when the lid body is in a state of closing off the opening.

4. The vehicle trunk internal storage compartment structure according to claim 1, further comprising a second end portion guide member, provided within the storage recess at the floor portion side and capable of guiding the second end portion of the link member in a direction that is orthogonal to the axial line of relative rotation of the link member with respect to the floor portion side.

5. The vehicle trunk internal storage compartment structure according to claim 1, wherein the storage recess is provide at a seat rear direction side of a vehicle seat, and the vehicle trunk internal storage compartment structure further comprises:
a stowing mechanism that moves the vehicle seat from the seat use position and stows the vehicle seat in the storage recess; and
a coupling mechanism, coupling the lid body to movement of the vehicle seat in the state in which the vehicle seat is being moved by the stowing mechanism in the direction of stowing in the storage recess, and moving the lid body out of the way from a position in which it is covering the opening of the storage recess.

6. The vehicle trunk internal storage compartment structure according to claim 5, wherein the coupling mechanism, in the state in which the vehicle seat is being moved by the stowing mechanism in the direction of stowing in the storage recess, presses the lid body positioned covering the opening of the storage recess in a direction that is toward the opposite side to the seat use position side and moves the lid body.

7. The vehicle trunk internal storage compartment structure according to claim 6, wherein an edge portion of the opening to the storage recess, at the opposite side of the storage recess from the seat use portion side, is angled, on progression in the vehicle up direction, toward the opposite side from the seat use portion side.

8. The vehicle trunk internal storage compartment structure according to claim 1, wherein the first end portion guide member comprises a groove that is formed at side portions at opposite sides of the lid body.

9. The vehicle trunk internal storage compartment structure according to claim 1, further comprising a second end portion guide member, provided within the storage recess at the floor portion side and capable of guiding the second end portion of the link member in a direction that is orthogonal to the axial line of relative rotation of the link member with respect to the floor portion side, wherein the second end portion guide member comprises a support rail that is fixed so as to be able to be anchored to a bottom wall portion of the storage recess.

10. The vehicle trunk internal storage compartment structure according to claim 1, wherein the storage recess is provided at a seat rear direction side of a vehicle seat, and the lid body is configured so as to be able to be latched to the rear face of the vehicle seat when the lid body is in an open state.
